(19) United States
(12) Patent Application Publication
(10) Pub. No.: US 2026/0073360 A1
(43) Pub. Date: Mar. 12, 2026

(54) Machine-Based Selection or Modification of an Appointment Duration

(71) Applicant: Oracle International Corporation, Redwood Shores, CA (US)

(72) Inventors: Jennifer Darmour, Seattle, WA (US); Orry Soegiono, Bellevue, WA (US); Micah Lawler Sonderman, San Antonio, TX (US)

(73) Assignee: Oracle International Corporation, Redwood Shores, CA (US)

(21) Appl. No.: 18/938,791

(22) Filed: Nov. 6, 2024

Related U.S. Application Data
(60) Provisional application No. 63/691,585, filed on Sep. 6, 2024.

(51) Int. Cl. G06Q 10/1093; G06N 20/00

(52) U.S. Cl. CPC G06Q 10/1093; G06N 20/00

(57) ABSTRACT

Techniques are disclosed that determine time allotments for appointments based on activities to be performed. A system determines a time allotment for an appointment by applying a machine learning model trained to calculate a duration for performing a set of activities involved in the appointment. The machine learning model may calculate the duration based on the set of activities, the timing of the appointment, and attributes of the provider.

This application claims the benefit of U.S. Provisional Patent Application 63/691,585, filed Sep. 6, 2024 which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to information technology adapted for administrative purposes. In particular, the present disclosure relates to technology for scheduling activities.

### BACKGROUND

Computer-implemented scheduling systems execute a sequence of steps that book times for future services, events, or activities. For example, in the healthcare context, when a patient schedules an appointment with a healthcare provider, the provider's scheduling system gathers various details, including the patient's name, reason for the appointment, and preferred appointment time. Then the scheduling system confirms the appointment with the patient based on the provider's schedule. On the day of the appointment, the provider attempts to maintain the daily schedule by completing the appointments scheduled within their assigned time frames, so patient appointments start on time.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1A illustrates a functional flow block diagram of an example architecture for a scheduling system in accordance with one or more embodiments;

FIG. 1B illustrates a block diagram of an example provider system in accordance with one or more embodiments;

FIGS. 2A, 2B, and 2C illustrate a set of operations of an example process for determining time allotments for appointments based on activities to be performed in the appointments in accordance with one or more embodiments;

FIGS. 3A and 3B illustrate a set of operations of an example process for determining updated time allotments for upcoming appointments based on activities to be performed in the appointments in accordance with one or more embodiments;

FIGS. 4A, 4B, 4C, and 4D illustrate example data structures in accordance with one or more embodiments;

FIG. 5 illustrates a time flow diagram of an example embodiment of determining a time allotment for an appointment based on activities to be performed in the appointment in accordance with one or more embodiments; and

FIG. 6 illustrates a block diagram of an example computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. SCHEDULING SYSTEM ARCHITECTURE
3. PROVIDER SYSTEM ARCHITECTURE
4. DETERMINING TIME ALLOTMENTS FOR APPOINTMENTS
5. EXAMPLE PROCESS OF DETERMINING A TIME ALLOTMENT
6. HARDWARE OVERVIEW
7. MISCELLANEOUS; EXTENSIONS

### 1. General Overview

One or more embodiments determine time allotments for appointments based on activities to be performed in the appointments and historical data corresponding to prior activities. An example system determines a time allotment for an appointment by applying a machine learning model trained to calculate a duration for performing a set of activities involved in the appointment. The machine learning model may calculate the duration based on the set of activities, the timing of the appointment, and attributes of the provider. Using the predicted duration, the system generates a recommended time allotment for scheduling the appointment.

Some embodiments modify time allotments for appointments to accommodate changes in the activities to be performed during the appointments. An example system receives a message from a user regarding an upcoming appointment that has an allotted time period for performing a set of activities to be performed during the appointment. Based on the message, the system determines an updated set of activities. The system then determines a predicted duration for the appointment by applying a machine learning model to the updated set of activities. Using the predicted duration, the system generates a recommendation to modify the time allotted for the appointment in a schedule. Subsequent to completing the appointment, the system determines an actual duration of the appointment and actual activities completed during the appointment. They system then retrains the machine learning model based on the completed combination of activities in association with the actual duration.

Systems and methods in accordance with the present disclosure enhance the capability of computing systems to handle complex scheduling scenarios. More specifically, embodiments improve on existing technology by using machine learning to analyze large volumes of historical data to identify otherwise unrecognizable patterns in multidimensional attributes of appointments, such as activities, dates, times, seasons, provider performance, and client demographics. By doing so, embodiments optimize utilization of processing resources to enhance the efficiency and accuracy of computer-implemented scheduling systems. Additionally, embodiments improve on existing scheduling technology by using machine learning to generate bespoke appointment recommendations for particular providers depending on the activities involved in appointments, the timing of appointments, and the attributes of providers themselves. Moreover, the machine learning-based scheduling system iteratively updates the machine learning model using data from actual appointments of providers to improve the accuracy of scheduling recommendations for the providers over time.

One or more embodiments described in this Specification and/or recited in the claims may not be included in this General Overview section.

### 2. Scheduling System Architecture

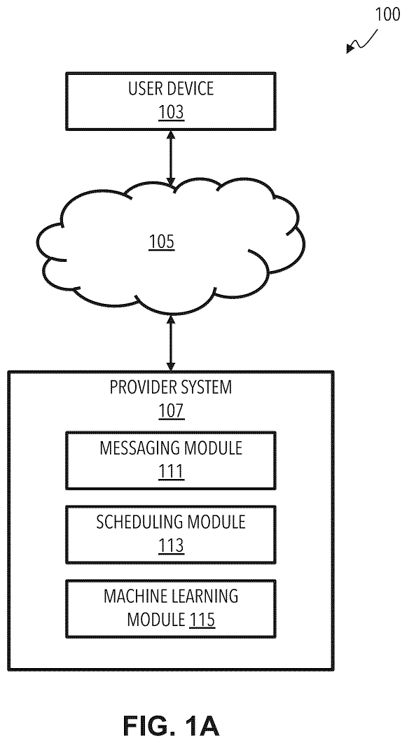

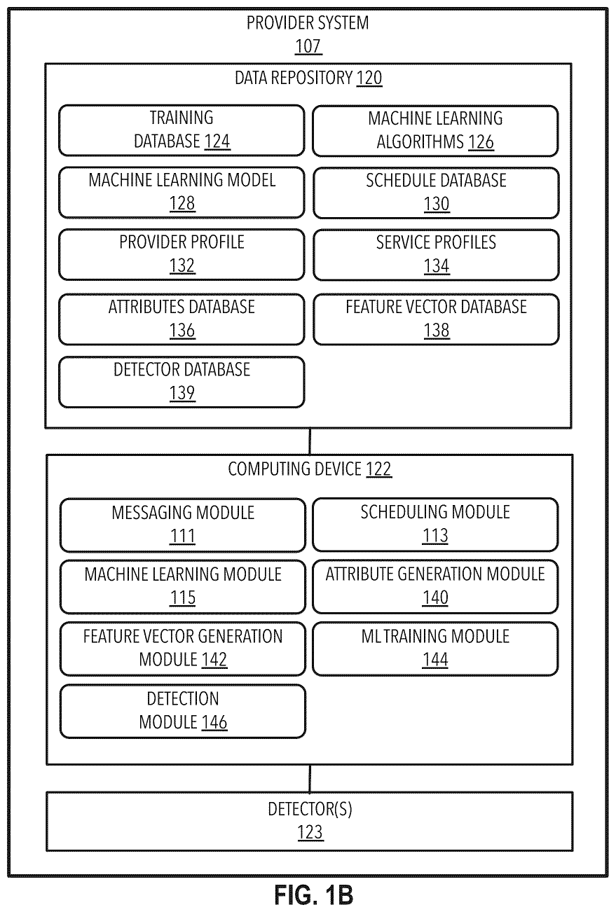

FIG. 1 illustrates an example architecture for a scheduling system 100 in accordance with one or more embodiments. The scheduling system 100 manages the time allocated to appointments for providers based on activities to be performed during the appointments. The providers include any type of entity that schedule services and activities. Example providers include healthcare providers, professional businesses, retail businesses, government entities, educational institutions, and the like. A service includes a piece of work that includes performance of one or more activities for a user. An activity is a distinct task included in an individual service. For example, in the healthcare context, services may include check-ups, immunizations, screenings, diagnostics, treatment of acute and chronic illnesses, surgical procedures, referrals, and counseling. The immunization service may include three activities: (1) medical history review, (2) body temperature measurement, and (3) administration of a vaccine.

As illustrated in FIG. 1, the scheduling system 100 includes a user device 103, and a provider system 107 that are communicatively connected, directly or indirectly, via one or more communication links 105. In one or more embodiments, the scheduling system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

The user device 103 includes one or more computing devices communicatively linked with provider system 107 for booking and managing appointments for users. A user can be any individual, such as a patient of a healthcare provider, a client of a retail service, a student of an educational institution, a consumer of a government service, etc. The user device 103 may be a personal computer, workstation, server, mobile device, mobile phone, tablet device, and/or other processing device capable of implementing and/or executing software, applications, etc. The user device 103 generates a computer-user interface enabling a user to access, perceive, and interact with the provider system 107. For example, the user device 103 may include an application that displays a user interface through which a user views available time frames for appointments and books a selected appointment. The user interface may also include a messaging client enabling communication between the user and the provider system 107 to submit queries regarding appointments. Embodiments of the messaging client may be a graphical user interface (GUI) that allows the user to interact with the provider system 107 through visual elements, such as menus, buttons, icons, and dialog boxes. Additionally, or alternatively, the messaging client may be a chat application, such as a large language model (LLM), that uses natural language processing (NLP) to simulate human conversation through text or voice interactions.

The communication links 105 includes wired and/or wireless information communication channels, such as the Internet, an intranet, an Ethernet network, a wireline network, a wireless network, a mobile communications network, and/or another communication network. For example, the user device 103 may communicate with the provider system 107 via the Internet by exchanging data packets through a Wi-Fi or cellular data network connection.

The provider system 107 includes one or more computing devices that schedule and manage appointments with users via the user device 103. As described in greater detail below, the provider system 107 may include a messaging module 111, a scheduling module 113, and a machine learning module 115. The messaging module 111 generates, sends, receives, and interprets communications and messages from users of the user device 103. For example, the messaging module 111 may generate a web page displaying a GUI at the user device 103 populated with data from the scheduling module 113. Additionally, or alternatively, the messaging module 111 may be execute an LLM that exchanges and interprets messages with the user device 103 via text and voice interactions. The scheduling module 113 may be software that records, manages, and retrieves appointment details for the provider system 107. The machine learning module 115 may execute a model trained to determines durations of appointments based on sets of activities as well as other information such as provider attributes and appointment timing.

In a non-limiting example in a healthcare context, a patient has an upcoming appointment for annual physical exam with a healthcare clinic using the provider system 107. The appointment may be scheduled for Jan. 4, 2024, from 9:00 a.m. to 9:30 a.m. with Dr. Jones. The physical exam may include a set of activities, such as a medical history review, vitals measurements, physical exam, lab test review, and follow-up discussion. Prior to the upcoming appointment, the patient uses the user device 103 to send a message to the provider system 107 via the network 105 requesting that the healthcare clinic add a vaccination to the patient's appointment. The messaging module 111 receives the message from the user device 103, and using an LLM, interprets the intent and content of the message as requesting a vaccination be included in the upcoming the appointment. The scheduling module 113 receives the request to modify the upcoming appointment to add the vaccination to the appointment and determines a set of one more activities involved with that service. Some of the activities included in the vaccination service may be redundant with the activities of the original examination. For example, both the vaccination service and the physical exam service may include performing a medical history review and taking vitals measurements. The scheduling system 113 determines an updated set of activities, including the activities from both the examination and the vaccination, excluding the duplicate activities. Then, scheduling module 113 triggers machine learning module 115 to determine a predicted duration for the appointment based on the updated set of activities. The machine learning module 115 applies a machine learning model trained to calculate the duration based on the set activities, attributes of the healthcare clinic (e.g., doctor identification and average wait time), and the timing of the appointment (e.g., a.m. appointment and winter season). Using the duration determined by the machine learning module 115, the scheduling module 113 determines an updated time allotment for the appointment. The updated time allotment may be an extension of the time frame in the schedule for the original appointment (e.g., Jan. 4, 2024, from 9:00 a.m. to 9:40 a.m.) or a different time frame that accommodates the increased time allotment (e.g., Jan. 5, 2024, from 8:30 a.m. to 9:10 a. m.). Additionally, the scheduling module 113 triggers the messaging module 111 to generate a message to the user device 103 proposing the updated time allotment for the appointment. On the day of the appointment, the provider system 107 detects actual duration of the appointment. For example, the provider system 107 may use sensors to detect when the patient enters and leaves an examination room. Based on the actual duration and the activities performed in the appointment, the provider system 107 retrains the machine learning model.

### 3. Provider System Architecture

FIG. 1B is a block diagram illustrating a provider system 107 in accordance with one or more embodiments. The provider system 107 includes hardware and software that perform processes and functions described herein. In one or more embodiments, the provider system 107 includes more or fewer components than the components illustrated in FIG. 1B. The components illustrated in FIG. 1B can be local to or remote from each other. The components illustrated in FIG. 1B can be implemented in software and/or hardware. Components can be distributed over multiple applications and/or machines. Multiple components can be combined into one application and/or machine. Operations described with respect to one component can instead be performed by another component.

One or more embodiments of the provider system 107 include a data repository 120, a computing device 122, and a detector 123. The data repository 120 includes any type of storage unit and/or device (e.g., a file system, database, collection of tables, or any other storage mechanism) for storing data. Furthermore, a data repository 120 can include multiple different storage units and/or devices. The multiple different storage units and/or devices may or may not be of the same type or located at the same physical site. Furthermore, the data repository 120 can be implemented or executed on the same computing system as the provider system 107. Additionally, or alternatively, the data repository 120 can be implemented or executed on a computing system separate from the provider system 107. The data repository 120 can be communicatively coupled, wired and/or wirelessly, to the provider system 107 via a direct connection or via a network. In one or more embodiments, the data repository 120 stores a training database 124, machine learning algorithms 126, a machine learning model 128, a schedule database 130, provider profile 132, service profiles 134, attributes database 136, a feature vector database 138, and a detector database 139.

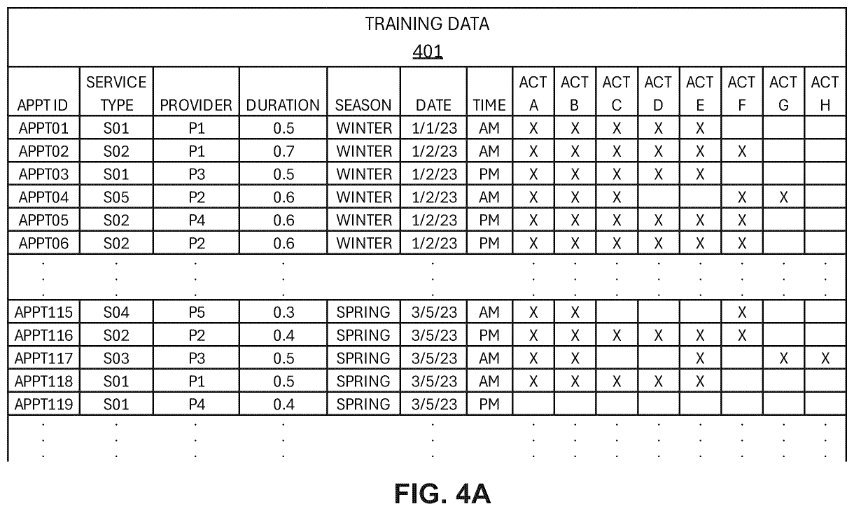

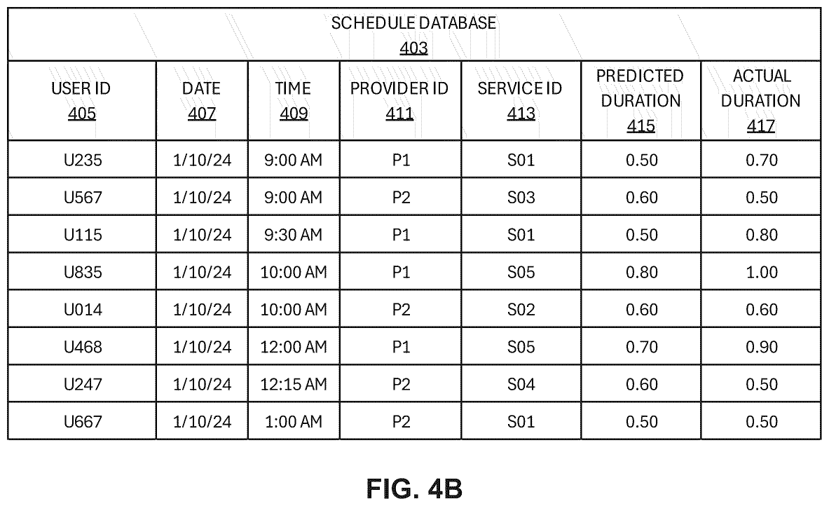

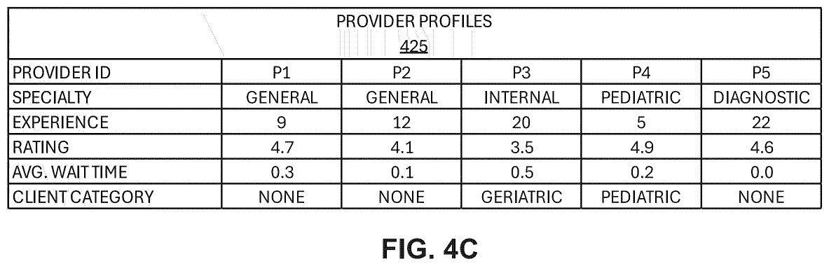

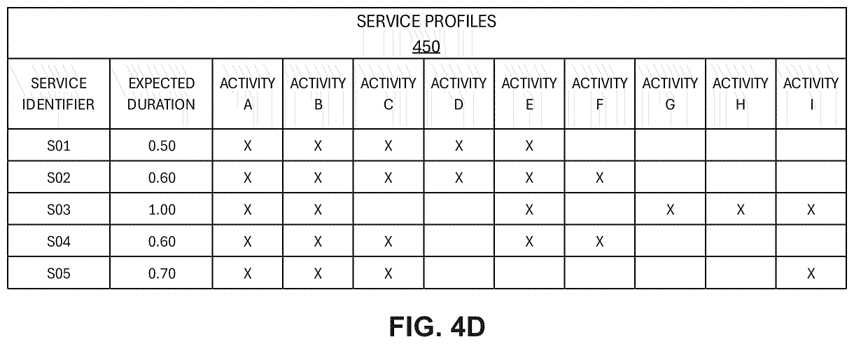

The training database 124 is one or more data structures storing sets of training data for training the machine learning models 128. The training data sets are records including data describing prior appointments. FIG. 4A illustrates an example data structure 401 storing training data sets, including appointment identifiers, service types, (e.g., checkup, acute illness, chronic illness, minor procedure, and diagnostic), provider identifiers, appointment durations, appointment timing (e.g., season, data, time), and activities performed (e.g., vaccination). The training data may be linked to additional appointment data, such as provider experience, provider wait time, durations of the appointments, and client demographics. Additionally, the training data sets may indicate appointment status information indicating if appointments were completed, cancelled, or rescheduled. Furthermore, the training data sets may include context information indicating reasons for service and external factors, such as emergencies, holidays, or other events that may affect the timing and duration of appointments.

The machine learning algorithms 126 are one or more algorithms that iteratively train the machine learning model 128 to map a set of input variables to an output variable. In particular, the machine learning algorithms 126 are configured to train the machine learning model 128 to map activities, appointment timing, and provider attributes to durations of an appointment. The machine learning algorithm 126 generates the target machine learning model 128 such that the target model best fits the datasets of training data to the labels of the training data. Additionally, or alternatively, a machine learning algorithm 126 generates the target machine learning mode 128 such that, when the model is applied to the sets of the training data, a maximum number of results determined by the target model matches the labels of sets of the training data. Different target models can be generated based on different machine learning algorithms and/or different sets of training data. The algorithms may include supervised components and/or unsupervised components. Algorithms, such as linear regression, logistic regression, linear discriminant analysis, classification and regression trees, naïve Bayes, k-nearest neighbors, learning vector quantization, support vector machine, bagging and random forest, boosting, backpropagation, and/or clustering can be used.

The scheduling database 130 is one or more data structures that store details for appointments. The scheduling database 130 associates users with appointment details, including appointment timing, provider profiles, service types, activities, and durations. For example, FIG. 4B illustrates an example data structure 403 storing schedule database 130 that associates particular user identifiers 405 with respective appointment dates 407, appointment times 409, provider identifiers 411, service identifiers 413, expected durations 415, and actual durations 417. The user identifiers 405 may be linked to user accounts and profiles, including numerous details, such as full name, address, contact information, date of birth, age, gender, history (e.g., medical history), etc. The provider identifiers 411 may be linked to provider profiles (e.g., data structure 425 illustrated in FIG. 4C). The service identifiers 413 may be linked to service profiles (e.g., data structure 450 illustrated in FIG. 4D) that associate the service identifiers 413 with corresponding service types, expected durations, and sets of activities.

The provider profiles 132 are one or more data structures associating providers with sets of attributes. FIG. 4C illustrates an example data structure 425 storing provider profiles 132 associating particular provider identifiers with respective specialties, experience, performance rating, average wait time rating, and client category. The attributes can include or be linked to other provider information, such as full name, location, and availability.

The service profiles 134 are one or more data structures associating services with corresponding sets of one or more activities involved in the services. For example, the service profiles 134 may associate different healthcare examinations and procedures with corresponding activities to be completed during those services. FIG. 4D illustrates an example data structure 450 storing service profiles 134 associating particular service identifiers with respective durations of the services and sets of activities to be completed in the services.

The attributes database 136 includes one or more data structures storing sets of attributes representing individual appointments. The sets of attributes include information of particular appointments that may be used to determine feature vectors for processing by the machine learning model 128. For example, the attributes of a particular appointment may include a service type of the appointment, a provider identifier, one or more attributes of the provider, and timing of the appointments activities associated with the appointment. Some attributes may be generated based on other attributes. For instance, the date and time of an appointment may be used to determine the season (e.g. spring) and time of day (e.g. morning) when the appointment occurred.

The feature vector database 138 is one or more data structure storing feature vectors generated used the attributes for appointments. Feature vectors include one-dimensional arrays containing attributes. For example, if the attributes of an appointment included age, appointment day of the week, and appointment type, a feature vector for the appointment may be [25, 2, 1] for a 25-year-old patient, on a Tuesday, for a physical exam.

The detector database 139 is one or more data structures storing location and timing information associated with the actual duration appointments. For individual appointments, the detector database 139 may store records log users'check-in time and checkout time. Additionally, the records may log the time and location of users and providers perform services and activities. For example, in a healthcare context, the detector database 139 may record the times a patient occupies a waiting room and an examination room holding the patient. Additionally, the detector database 139 may record times at which the doctor or other staff enter and exit the examination room.

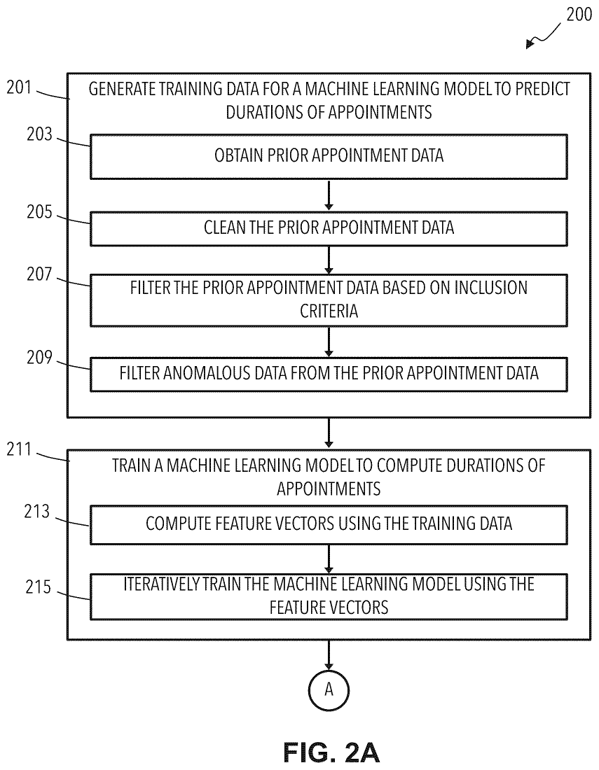

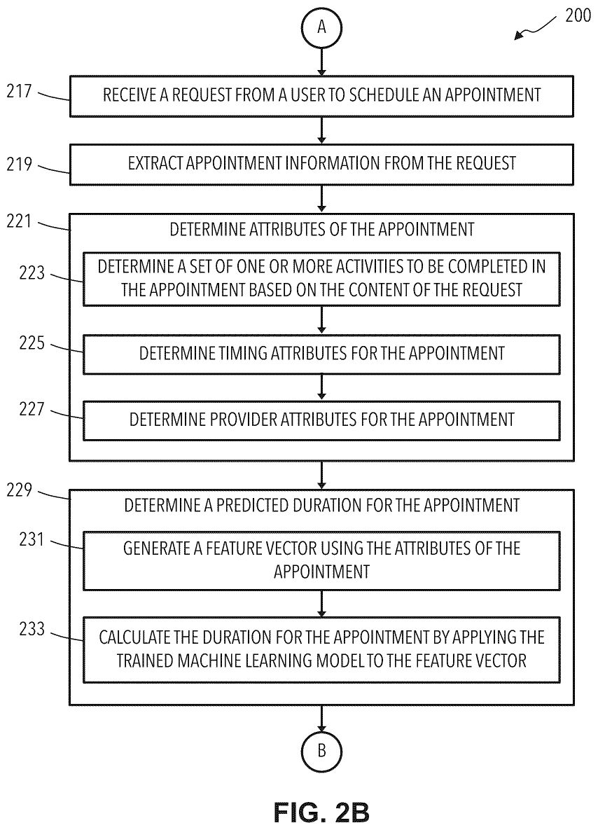

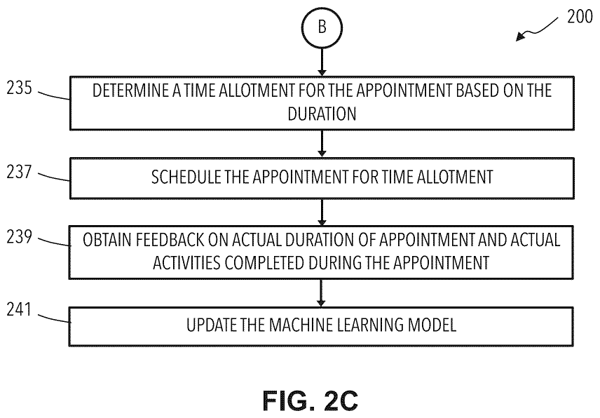

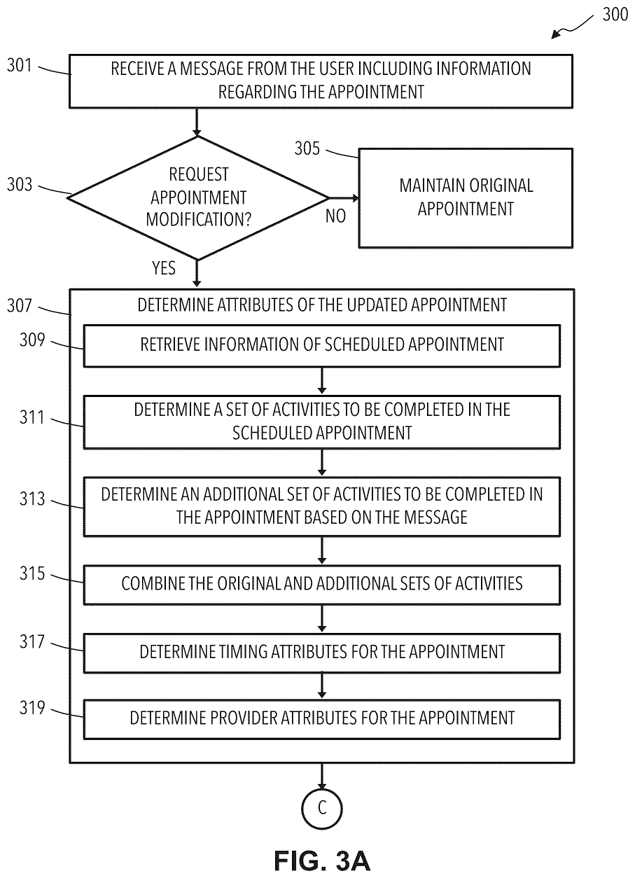

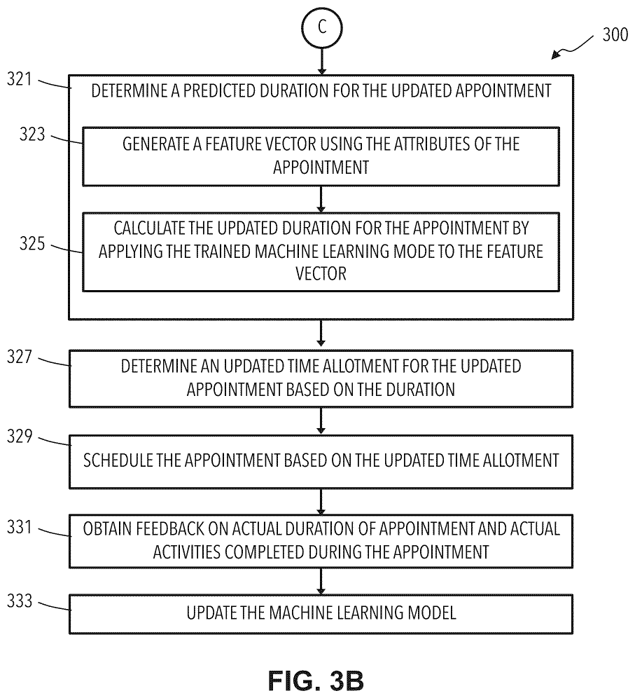

In one or more embodiments, the computing device 122 includes hardware and/or software configured to perform operations described herein. Example operations are described below with reference to FIGS. 2A, 2B, 2C, 3A, and 3B. The computing device 122 executes computer-readable program instructions, such as an operating system and application programs that are stored in memory devices and/or the storage system. Additionally, the computing device 122 executes program instructions of messaging module 111, scheduling module 113, and machine learning model 115, which may be the same as those described above. Moreover, the computing device 122 executes program instructions of an attribute generation module 140, a feature vector generation model 142, a machine learning (ML) training module 144, and a detection module 146.

The attribute generation module 140 generates attributes from appointment details, provider profiles, service profiles, and/or user messages. The attribute generation module 168 may query the schedule database 130, the provider profiles 132, and the service profiles 134 to extract the attributes and store the extracted attributes in the attributes database 136. Additionally, the attribute generation module 168 may obtain attributes for appointments from content of user messages using, for example, using an LLM and other NLP techniques to extract, for example, appointment dates, time, locations, providers, and services.

The feature vector generation model 142 generates feature vectors for application to the machine learning model 128. As described above, feature vectors include one-dimensional arrays containing attributes of appointments. For example, the feature vector generation module 142 may generate feature vectors for a particular appointments using attributes stored in the attributes database 136 and then store the feature vectors in the feature vector database 138.

The machine learning (ML) training module 144 trains one or more machine learning models to determine durations of appointments. The machine learning (ML) training module 144 may iteratively apply the feature vectors generated by the feature vector generation module 142 from data in the training database 124 to one of the machine learning algorithms 126. For example, the machine learning model 128 may be trained to map activities, appointment timing, and provider attributes to predicted durations of appointments.

The detection module 146 detects the start and end time of appointments to determine the actual durations of the appointments. One or more embodiments of the detection module 146 obtain check-in and checkout times from users a kiosk, user device, or receptionist. Additionally, the detection module 146 may detect users'and providers'locations using one or more detectors 123. The detectors 123 include sensors, such cameras, microphones, and/or indoor positioning sensors using RF receivers (e.g., BLUETOOTH, WIFI, and RFID) that identify and track users and providers during appointments.

### 4. Determining Time Allotments for Appointments

FIGS. 2A, 2B, and 2C illustrate a set of operations of an example process 200 for training and using a machine learning model to determine predicted time allotments for appointments based on activities to be performed in the appointments in accordance with one or more embodiments. One or more operations of the process 200 illustrated in FIGS. 2A, 2B, and 2C may be modified, rearranged, or omitted. Accordingly, the particular sequence of operations should not be construed as limiting the scope of one or more embodiments.

Referring to FIG. 2A, a system generates training data for training a machine learning model to predict durations of appointments (Operation 201). Generating the training data includes obtaining data of prior appointments. The prior appointment data may include activities, timing, providers attributes, durations, status, and context (Operation 203). For example, in a healthcare context, the prior appointment data may include a service type, a date, a time, and the appointment duration. Example provider profile information may include an identity, a specialty, provider experience level, a performance rating, and patient demographics. Example status information may include indicators regarding if the appointment was completed, cancelled, or rescheduled. Example context information indicating reasons for appointments, if the appointments occurred on peak hours or dates, and external factors, such as emergencies, holidays, or other events. Generating the training data also includes cleaning the prior appointment data (Operation 205). Cleaning may include removing duplicate appointment records, filling or removing missing data, and standardizing data formats. For example, the system may remove records having matching appointment identifiers and appointments lacking duration or activity information.

Generating the training data further includes filtering the prior appointment data based on inclusion criteria to remove data points that are out of context (Operation 207). Out of context data points include incorrect or irrelevant data that may skew the training data. The inclusion criteria comprises logical and/or heuristic rules for identifying data points that are out of context. Some inclusion criteria can define certain ranges of durations, dates, and times for inclusion in the training data. In a healthcare context, inclusion criteria may filter the prior appointment data based on type, timing, duration, and/or scope. For example, the system may filter the prior appointment data to include appointments that satisfy the following: (a) complete, (b) non-emergency, (c) occurred between 9:00 a.m. and 4:00 p.m., (d) occurred on non-holidays, (e) had durations between 10 and 45 minutes, and (f) involved fewer than seven activities.

Additionally, generating the training data includes filtering the prior appointment data to remove anomalous data (Operation 209). Anomalous data includes data points that occur significantly less frequently than other data points in the prior appointment data. Such data points may represent outliers or noise that can skew the training data. The system identifies the anomalous data using one or more frequency thresholds for assessing the frequency of occurrence of data points. In a healthcare context, the system may exclude appointments having attributes, such as duration, timing, and set of activities, that occurred less than a frequency threshold. For example, the system can categorize the data points in the prior appointment data based on their duration and count the occurrences of the individual durations. The system may then remove data points having durations that occur less than one percent of the time. By doing so, the training data excludes extraordinarily long or short appointments that occurred for anomalous reasons.

Using the training data, the system trains a machine learning model to compute predicted durations of appointments based on activities to be completed during the appointments (Operation 211). Training the machine learning model includes computing feature vectors using the training data (Operation 213). As previously described, computing the feature vectors includes generating one-dimensional arrays of values representing relevant attributes of the appointments. For example, generating feature vectors for a particular appointment includes transforming attributes of the appointment into one-dimensional array of numerical values.

Training the machine learning model also includes iteratively applying the feature vectors for the training data to a machine learning algorithm (Operation 215). The machine learning training algorithm may apply the feature vectors as inputs and the respective durations as labels. The algorithm can be, for example, a linear regression algorithm or a random forest algorithm. Based on the inputs and labels, the algorithm iteratively learns the relationship between the attributes of the appointments and the and the duration of the appointments. Additionally, techniques like grid search or random search may be used to identify the best hyperparameters for the model. A subset of the training data can be used to verify that the trained machine learning model is sufficiently accurate by comparing the durations output of the model to the known durations of the training data. Evaluation metrics, such as F1-score, mean squared error, and R-squared, can be used to assess the performance of the model for iteratively improving the model until its accuracy is sufficient for deployment to a production environment.

Proceeding to FIG. 2B, as indicated by off-page connector “A,” the system receives a request from a user to schedule an appointment (Operation 217). The appointment may involve a provider performing one or more activities. Some embodiments receive the request from a user device, such as a personal computer or a smartphone. The request may comprise data, audio, video, or text transmitted from a GUI and/or a chat application. For example, the system may receive a user's selection of one or more events, services, or activities to be performed at the appointment from a web application that displays a form or menu configured to receive inputs of appointment details. Alternatively, the system may receive the user's selection as conversational text using an LLM through chat bot application presented on the user device.

The system extracts appointment information from the request (Operation 219). The appointment information may be extracted from the content and metadata of the request. The metadata may include user-identifying information, for example, an email address, telephone number, or other information that the system may use to associate the request with a user's profile, account, and appointments. The content of the request includes the appointment information, such as the date, time, location, provider, and reasons for the appointment. Some embodiments use the LLM to extract and interpret the content and intent of the message. The system may convert the message to text and parse the text to identify keywords and phrases. For example, if the message includes phrases like “checkup,” the system uses intent recognition algorithms to classify the objective of the message as requesting an appointment for an annual physical examination.

The system determines attributes for the requested appointment (Operation 221). The attributes describe the activities, the timing, and the provider of the appointment to determine a duration of the appointment. The attributes can include information extracted from the request as well as information retrieved or generated based on the request. Determining the attributes includes determining a set of one or more activities to be completed in the appointment based on the content of the request (Operation 223). Using terms and or keywords of services extracted from the request, the system can identify a corresponding set of activities included in the service. Some embodiments retrieve the set of activities corresponding to a service from a database. For example, FIG. 4D illustrates a data structure 450 associating service identifiers with respective sets of activities.

Determining the attributes may also include determining timing attributes for the appointment (Operation 225). Timing attributes include one or more of a date, a time, and time frame. The system may extract the timing attributes from the request and/or infer the timing attributes. For example, the user's request may indicate “the week of March 4th,” “next week,” “March 4th at 11 a.m. ,” or “the morning of March 4th.” The system may use NLP to extract the time frame and interpret the preferred time of day (e.g., “morning”) and the season (e.g., “spring”). The system then accesses the service provider's scheduling database to check the availability for the request. For example, the system can query a scheduling database, such as illustrated in FIG. 4B, to identify available time slots that may be allotted to the user.

Determining the attributes may further include determining provider attributes for the appointment (Operation 227). Provider attributes may include a provider identity, location, specialty, experience, rating, wait time, and client category. The system may extract the provider identification from the request (e.g., “Dr. Jones”). Additionally, using the provider identification, the system can access a database of provider profiles including attributes of particular providers. For example, the system can query a database of provider profiles such as illustrated in FIG. 4C.

The system determines a predicted duration for the appointment using the machine learning model (Operation 229). Determining the duration includes generating a feature vector using the attributes of the appointment (Operation 231). An example subset of the appointment attributes that may be included in the feature vector include the activities, season, time frame, provider identification, and specialty. Determining the duration includes calculating the duration for the appointment by applying the trained machine learning model to the feature vector (Operation 233). The machine learning model calculates the duration of an appointment based on the attributes of the event by processing the input feature vector using the trained algorithm, which uses the learned relationships and patterns to predict the output. For example, if the attributes include activities, season, time frame, provider identification, and specialty, the model applies the coefficients or decision rules the model has learned to these features to generate a predicted duration reflecting the complex interactions between the various attributes as identified during the training of the machine learning model.

Proceeding to FIG. 2C, as indicated by off-page connector “B,” the system determines a time allotment for the appointment based on the duration (Operation 235). Determining the time allotment may include rounding up the duration determined by the machine learning model to a next time increment such as the next tenth of an hour. For example, if the machine learning model estimates the duration of the appointment will be 0.63 hours, the system may round the allotment to 0.7 hours. Additionally, or alternatively, determining the time allotment may include identifying a time frame in the schedule extending the original appointment or identifying a different time frame in the schedule the accommodates the predicted duration. The system may identify the time frame by accessing the schedule database to check the availability of the provider in a time frame meeting or exceeding the time allotment in the user's requested time frame.

The system schedules the requested appointment based on determined time allotment (Operation 237). Once a suitable time allotment is identified, the system updates the schedule to book the corresponding time frame. Additionally, the system may generate a confirmation message for the user, detailing the appointment time and any relevant information.

After the scheduled appointment is complete, the system obtains feedback on the actual duration of the appointment and the actual activities completed during the appointment (Operation 239). The feedback may comprise determining the difference between the duration predicted by the machine learning model and actual duration of the appointment. Some embodiments maintain a log or a database storing the predicted and actual durations of the appointment. As previously described, the system may determine the actual duration by detecting and recording users'check-in time and checkout time. Additionally, or alternatively, the system may determine the actual duration by using sensors to detect and record the location of users and providers during the appointments. For example, in the healthcare context, the system may use facial recognition systems, indoor positioning systems, and/or tracking applications on users'mobile devices to detect when providers and patients occupy an examination room.

The system may also obtain the feedback on the duration and activities completed during the appointment by executing scripts or other program code that extract information from post-appointment documentation used for compliance and billing. In the healthcare context, the system may extract the duration and activities from the electronic health records that document appointments. For example, the system may extract duration and activities from coding and billing documentation. Additionally, or alternatively, the system may use NLP techniques to extract the actual duration and activities from visit summaries generated by healthcare providers.

Using the feedback, the system updates the machine learning model (Operation 241). Updating the machine learning model may include updating the training data with newly generated appointment data, activities, and the duration feedback. Using the updated training data, the system iteratively retrains the machine learning model to improve the model's accuracy.

FIGS. 3A and 3B illustrate a set of operations of an example process 300 for using a machine learning model to determine predicted time allotments for upcoming appointments based on activities to be performed in the appointments in accordance with one or more embodiments. One or more operations of the process 200 illustrated in FIGS. 3A and 3B may be modified, rearranged, or omitted. Accordingly, the particular sequence of operations should not be construed as limiting the scope of one or more embodiments.

The system receives a message from the user including information regarding the appointment (Operation 301). The message may, for example, request a modification of the appointment to include an additional activity or service. They system may receive the request in the same or similar manner that was previously described regarding receiving a scheduling request.

The system determines if the message includes a request to modify the appointment (Operation 303). The system may receive the request in a same or similar manner to the one previously described regarding receiving a scheduling request. That is, the system may use an LLM or other NLP techniques that interpret the intent and content of the message to determine if the request includes an additional service. The system may convert the message to text and parse the text to identify keywords and phrases. If the system determines that the message does not include a request to modify the appointment with an additional service, then the system maintains the original appointment (Operation 305).

On the other hand, if the system determines that the message includes a request to modify the appointment with an additional service, then the system determines attributes for the updated appointment (Operation 307). Determining the attributes includes retrieving information associated with the originally scheduled appointment (Operation 309). The information may include the date, time, location, provider, and services associated with the scheduled appointment. The information can be stored in association with the entry in an appointment database. Determining the attributes also includes determining a set of activities to be completed in the scheduled appointment (Operation 311). Some embodiments determine the set of activities based on a service to be performed as identified in the appointment information or the user's original appointment request.

Additionally, determining the attributes includes determining a set of one or more additional activities to be completed in the modified appointment based on the content of the message (Operation 313). As previously described, the system may use terms and keywords of services extracted from the request to identify a corresponding set of activities included in the service. For example, in the healthcare context, the system may identify the term “vaccination” in the request, which is associated with service identifier (e.g., “S05”) that corresponds with a set of activities such as illustrated in FIG. 4D.

The system combines the original set of activities and the additional set of activities (Operation 315). For example, the system may calculate a union of the two sets of activities to generate a unified set of activities that excludes duplicate activities. Determining the attributes may also include determining timing attributes for the appointment (Operation 317). Timing attributes may include date, time, time frame, and season. As previously described, the system may use the requested date and time to generate a preferred time of day (e.g., “morning”) and the season (e.g., “spring”) of the appointment. Determining the attributes may further include determining provider attributes for the appointment (Operation 319). As previously described, provider attributes, such as a provider identity, location, specialty, experience, rating, wait time, and demographics, may be retrieved from a provider profile.

Proceeding to FIG. 3B, as indicated by off-page connector “C,” the system determines a predicted duration for the updated appointment (Operation 321). As previously described, determining the duration includes generating a feature vector using the updated attributes of the appointment (Operation 323). Additionally, determining the duration includes calculating the duration for the appointment by applying the trained machine learning model to the feature vector (Operation 325).

The system determines an updated time allotment for the appointment based on the duration predicted by the machine learning model (Operation 327). Determining the time allotment may include rounding up the duration determined by the machine learning model to a next time increment such as the next tenth of an hour. Additionally, or alternatively, determining the time allotment may include identifying a time frame in the schedule extending the original appointment or a booking a different time frame in the schedule the accommodates the predicted duration. The system schedules the original appointment based on the time allotment, timing, and service provider (Operation 329).

The system obtains feedback on the actual duration of the completed appointment (Operation 331). As previously described, the system may determine actual appointment duration by tracking both the user and provider using an application on the user's device and sensors in the provider's office. The feedback may comprise the difference calculated between the predicted duration and the actual duration of the appointment captured by the system. Additionally, the system may also obtain the feedback on the duration and activities completed during the appointment by extracting the information from post-appointment documentation, such as coding and billing documentation and/or appointment summaries. Using the feedback, the system updates the machine learning model (Operation 333). Updating the machine learning model includes incorporating the new appointment data along with the feedback into the training set and re-training the model to minimize errors in the predicted durations.

### 5. Example Process for Determining a Time Allotment

A detailed example is described below for purposes of clarity. Components and/or operations described below should be understood as one specific example which may not be applicable to certain embodiments. Accordingly, components and/or operations described below should not be construed as limiting the scope of any of the claims.

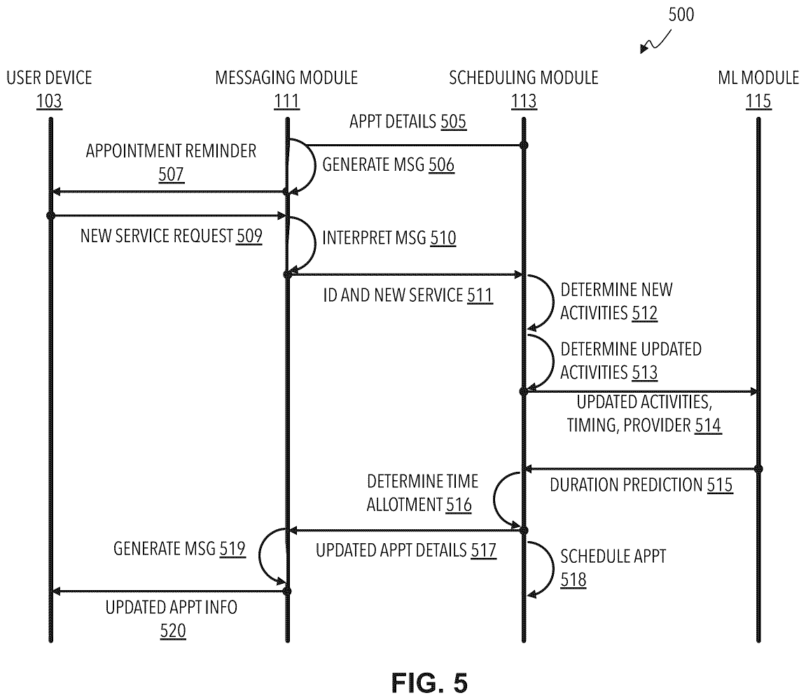

FIG. 5 illustrates a time flow diagram of an example process 500 that determines a time allotment for a patient's appointment with a doctor's office based on activities to be performed in the appointment in accordance with one or more embodiments. The process 500 involves a user device 103, a messaging module 111, a scheduling module 113, and a machine learning module 115 that each may be the same as those previously described. The user device 103 may be the patient's smartphone. The messaging module 111, a scheduling module 113, and a machine learning module 115 may be components of a server operated by the doctor's office as illustrated in FIG. 1.

One week prior to the patient's appointment date, predefined rules cause the scheduling module 113 to trigger sending a reminder message to the user device 103 by transmitting appointment details to the messaging module 111 (Operation 505). The scheduling module 113 retrieves a record from a scheduling database, including the appointment details. The appointment details may indicate the following information: appointment type is an annual health checkup; appointment date is Jan. 10, 2024; appointment time is 10:00 a.m. ; provider is Dr. Jones; allotted appointment time is 30 minutes. Additionally, the annual health checkup may be associated with a set of activities including (a) medical history review, (b) vital measurements, (c) physical exam, (d) lab test review, and (e) follow-up discussion.

The scheduling module 113 triggers the messaging module 111 to generate a natural language text message including the appointment details (Operation 506). For example, an LLM executed by the messaging module 111 may use the appointment details to generate a text message stating, “Your annual checkup is scheduled for January 10th at 10:00 a.m. Please let us know if you have any changes.” Then the messaging module 111 may send the appointment reminder to a messaging application at the user device 103 (Operation 507).

In accordance with the present example, the patient wishes to update their appointment by adding a vaccination to their annual checkup. Accordingly, the patient may use the messaging application to reply, “Can I add a vaccination to my appointment? ” The messaging module 111 receives and interprets the patient's reply (Operation 510). As detailed above, the messaging module 111 may identify the patient based on the reply's metadata. Also, the messaging module 111 may use NLP techniques to recognize the intent and content of the reply as a request to receive a vaccination during the upcoming appointment.

The scheduling module 113 receives the patient's identification information and new service from the messaging module 111 (Operation 511). The scheduling module 113 determines new activities involved in the vaccination service that may include (a) medical history review, (b) vital measurements, (c) procedure preparation, and (d) vaccination (Operation 512). Based on the new activities, the scheduling module 113 determines an updated set of activities for the appointment (Operation 513). Determining the updated set includes calculating a union of the original set of activities and the new set of activities that would include (a) medical history review, (b) vital measurements, (c) physical exam, (d) lab test review, (d) procedure preparation, (e) vaccination, and (f) follow-up discussion. The scheduling module 113 sends the attributes of the appointment, including activities, timing, and provider information, to the machine learning module 115 (Operation 514). Using the information received from the scheduling module 113, the machine learning module 115 determines an updated duration estimate for the appointment by applying a trained machine learning model. The model may be trained and updated using information of the particular provider. The scheduling module 113 receives the updated duration prediction from the machine learning module 115 (Operation 515). Using the updated duration prediction, the scheduling module 113 determines an updated time allotment for the appointment (Operation 516). Determining the updated time allotment may include extending the original time allotment or identifying a different time allotment in the schedule that accommodates the updated duration. The scheduling module 113 sends the updated time allotment and the other appointment details to the messaging module 111 to generate an updated appointment message (Operation 517). Additionally, the scheduling module 113 schedules the appointment by storing the appointment details in the scheduling database (Operation 518). The messaging module 111 generates a natural language text, including the update appointment details (Operation 519). Then the messaging module 111 sends the updated appointment information to the user device 103 (Operation 520).

### 6. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

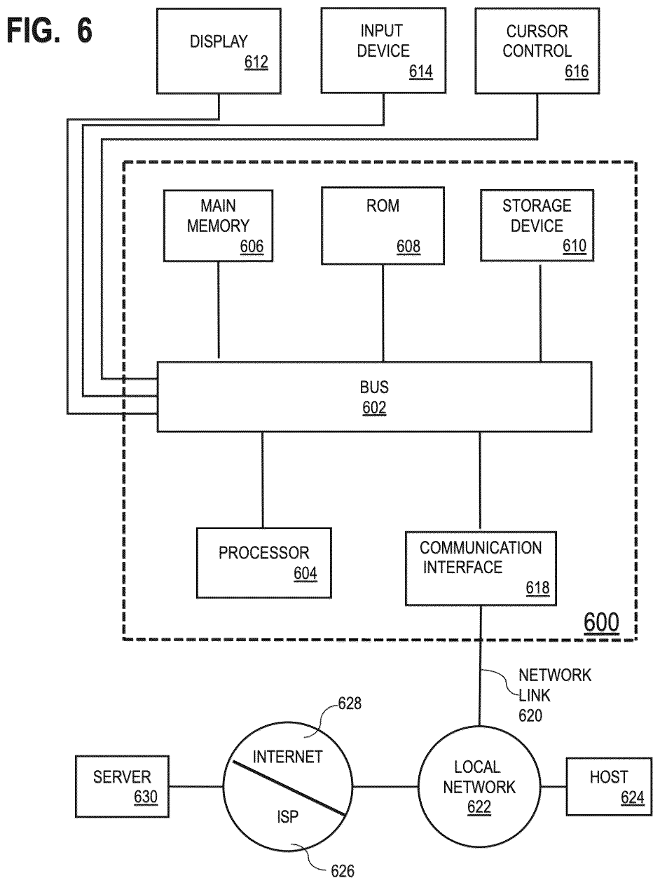

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or a Solid State Drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 7. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
generating a training data set for a machine learning (ML) model that estimates appointment duration based on a corresponding set of activities at least by:
determining a first duration of a first prior appointment for completing a first combination of activities;
including in a training data set the first combination of activities in association with the first duration;
training the ML model based on the training data set;
receiving a message regarding a particular appointment for a user;
based on the message, determining a second combination of activities to be completed during the particular appointment;
applying the ML model to the second combination of activities to determine a predicted duration for the particular appointment;
generating a recommendation to select a first allotted time period for the particular appointment based on predicted duration determined by the ML model;
subsequent to completion of the particular appointment, determining a detected duration of the particular appointment; and
retraining the ML model based on the second combination of activities in association with the detected duration of the particular appointment.

2. The one or more non-transitory computer readable media of claim 1, wherein generating the training data set for the ML model further comprises:
determining a second duration of a second prior appointment for completing a second combination of activities;
determining that the second combination of activities and/or the second duration does not meet an inclusion criteria for including the second combination of activities and the second duration in the training data set;
refraining from including the second combination of activities in association with the second duration in the training data set.

3. The one or more non-transitory computer readable media of claim 2, wherein determining that the second combination of activities and/or the second duration does not meet the inclusion criteria comprises at least one of:
determining that a frequency with which appointments are scheduled for completing the second combination of activities does not meet a threshold frequency;
determining that the second duration exceeds an appointment duration limit.

4. The one or more non-transitory computer readable media of claim 2, wherein determining that the second combination of activities and/or the second duration does not meet the inclusion criteria comprises at least one of:
determining that the second combination of activities and/or the second duration meets an anomalous data criteria.

5. The one or more non-transitory computer readable media of claim 1, wherein determining the first duration of the first prior appointment for completing the first combination of activities comprises:
monitoring sensor data corresponding to a location of an attendee associated with the first prior appointment to determine (a) a first time at which the location of the attendee matched a location of the first prior appointment and (b) a second time at which the location of the attendee no longer matched the location of the first prior appointment; and
determining the first duration based on a time interval between the first time and the second time.

6. The one or more non-transitory computer readable media of claim 1, wherein the operations further comprise:
applying a large language model to interpret the message to determine the second combination of activities.

7. The one or more non-transitory computer readable media of claim 1, wherein the operations further comprise:
applying a large language model to interpret the message to determine that a third combination of activities for the particular appointment has been modified to the second combination of activities, and
wherein the recommendation to select the first allotted time comprises a recommendation to modify a second allotted time, based on the third combination of activities, to the first allotted time based on the second combination of activities.

8. A method comprising:
generating a training data set for a machine learning (ML) model that estimates appointment duration based on a corresponding set of activities at least by:
determining a first duration of a first prior appointment for completing a first combination of activities;
including in the training data set the first combination of activities in association with the first duration;
training the ML model based on the training data set;
receiving a message regarding a particular appointment for a user;
based on the message, determining a second combination of activities to be completed during the particular appointment;
applying the ML model to the second combination of activities to determine a predicted duration for the particular appointment;
generating a recommendation to select a first allotted time period for the particular appointment based on predicted duration determined by the ML model;
subsequent to completion of the particular appointment, determining a detected duration of the particular appointment; and
retraining the ML model based on the second combination of activities in association with the detected duration of the particular appointment.

9. The method of claim 8, wherein generating the training data set for the ML model further comprises:
determining a second duration of a second prior appointment for completing a second combination of activities;
determining that the second combination of activities and/or the second duration does not meet an inclusion criteria for including the second combination of activities and the second duration in the training data set;
refraining from including the second combination of activities in association with the second duration in the training data set.

10. The method of claim 9, wherein determining that the second combination of activities and/or the second duration does not meet the inclusion criteria comprises at least one of:
determining that a frequency with which appointments are scheduled for completing the second combination of activities does not meet a threshold frequency;
determining that the second duration exceeds an appointment duration limit.

11. The method of claim 9, wherein determining that the second combination of activities and/or the second duration does not meet the inclusion criteria comprises at least one of:
determining that the second combination of activities and/or the second duration meets an anomalous data criteria.

12. The method of claim 8, wherein determining the first duration of the first prior appointment for completing the first combination of activities comprises:
monitoring sensor data corresponding to a location of an attendee associated with the first prior appointment to determine (a) a first time at which the location of the attendee matched a location of the first prior appointment and (b) a second time at which the location of the attendee no longer matched the location of the first prior appointment; and
determining the first duration based on a time interval between the first time and the second time.

13. The method of claim 8, further comprising:
applying a large language model to interpret the message to determine the second combination of activities.

14. The method of claim 8, further comprising:
applying a large language model to interpret the message to determine that a third combination of activities for the particular appointment has been modified to the second combination of activities, and
wherein the recommendation to select the first allotted time comprises a recommendation to modify a second allotted time, based on the third combination of activities, to the first allotted time based on the second combination of activities.

15. A system comprising:
at least one device including a hardware processor;
the system being configured to perform operations comprising:
generating a training data set for a machine learning (ML) model that estimates appointment duration based on a corresponding set of activities at least by:
determining a first duration of a first prior appointment for completing a first combination of activities;
including in a training data set the first combination of activities in association with the first duration;
training the machine learning model based on the training data set;
receiving a message regarding a particular appointment for a user;
based on the message, determining a second combination of activities to be completed during the particular appointment;
applying the ML model to the second combination of activities to determine a predicted duration for the particular appointment;
generating a recommendation to select a first allotted time period for the particular appointment based on predicted duration determined by the ML model;
subsequent to completion of the particular appointment, determining a detected duration of the particular appointment; and
retraining the ML model based on the second combination of activities in association with the detected duration of the particular appointment.

16. The one or more non-transitory computer readable media of claim 15, wherein generating the training data set for the ML model further comprises:
determining a second duration of a second prior appointment for completing a second combination of activities;
determining that the second combination of activities and/or the second duration does not meet an inclusion criteria for including the second combination of activities and the second duration in the training data set;
refraining from including the second combination of activities in association with the second duration in the training data set.

17. The one or more non-transitory computer readable media of claim 16, wherein determining that the second combination of activities and/or the second duration does not meet the inclusion criteria comprises at least one of:
determining that a frequency with which appointments are scheduled for completing the second combination of activities does not meet a threshold frequency;
determining that the second duration exceeds an appointment duration limit.

18. The one or more non-transitory computer readable media of claim 16, wherein determining that the second combination of activities and/or the second duration does not meet the inclusion criteria comprises at least one of:
determining that the second combination of activities and/or the second duration meets an anomalous data criteria.

19. The one or more non-transitory computer readable media of claim 15, wherein determining the first duration of the first prior appointment for completing the first combination of activities comprises:
monitoring sensor data corresponding to a location of an attendee associated with the first prior appointment to determine (a) a first time at which the location of the attendee matched a location of the first prior appointment and (b) a second time at which the location of the attendee no longer matched the location of the first prior appointment; and
determining the first duration based on a time interval between the first time and the second time.

20. The one or more non-transitory computer readable media of claim 15, wherein the operations further comprise:
applying a large language model to interpret the message to determine that a third combination of activities for the particular appointment has been modified to the second combination of activities, and
wherein the recommendation to select the first allotted time comprises a recommendation to modify a second allotted time, based on the third combination of activities, to the first allotted time based on the second combination of activities.
